(19) United States
(12) Patent Application Publication
(10) Pub. No.: US 2022/0123501 A1
(43) Pub. Date: Apr. 21, 2022

(54) PLUG CONNECTOR WITH LATCH

(71) Applicant: HIRSCHMANN AUTOMOTIVE GMBH, Rankweil/Brederis (AT)

(72) Inventors: Alexander DENZ, Feldkirch (AT); Manuel MAECHTINGER, Dornbirn (AT); Markus WINKEL, Goetzis (AT)

(21) Appl. No.: 17/426,707

(22) PCT Filed: Feb. 3, 2020
(86) PCT No.: PCT/EP2020/052577

§ 371 Date: Jul. 29, 2021

(30) Foreign Application Priority Data
Feb. 1, 2019 (DE) 10 2019 102 554.0

(51) Int. Cl. H01R 13/627; H01R 13/639

(52) U.S. Cl. CPC H01R 13/6272; H01R 13/641; H01R 13/639

(57) ABSTRACT

The invention relates to a plug-in connection, comprising: an electrical connector having an electrical connector housing (1); and a mating electrical connector (17), which can be plugged together with the electrical connector. The electrical connector has a superstructure (4), and the superstructure (4) receives a locking element (8) in a pre-latching position and in a final latching position. The electrical connector has first detent elements and the locking element (8) has first detent elements corresponding thereto. The mating electrical connector (17) has additional detent elements and the locking element (8) has additional detent elements corresponding thereto. The locking element (8) is first fastened to the electrical connector in the pre-latching position by means of the first detent elements corresponding to one another before the mating electrical connector is inserted into the electrical connector, and the additional detent elements corresponding to one another are actuated by the insertion of the mating electrical connector into the electrical connector, whereby the locking element (8) can be moved into its final latching position. The electrical connector housing (1) and the locking element (8) have third detent elements corresponding to one another, by means of which additional locking of the locking element (8) to the electrical connector is effected when the locking element has been moved into its final latching position. The superstructure (4) has a cut-out (7), and the locking element (8) has a detent protrusion (21), which can be moved into the cut-out (7). The locking element (8) has an elongate extension arm (9), at the one end of which an actuation pan (10) is arranged. The first detent elements are arranged in the front end region of the extension arm (9) remote from the actuation part and the third detent elements of the locking element (7) are arranged in the region of the extension arm (9) that adjoins the actuation part (10). The plug-in connection is characterized in that the extension arm (9) has two laterally arranged pins (13) in the region between the first, front detent elements and the third, rear detent elements, the electrical connector housing (1) having, at the height of each pin (13), a contact web (25) for an end face of the pin (13) in question, each contact web (25) being spaced apart from the electrical connector housing (1) by a slot (26).

The invention relates to a plug connection assembly comprising a main plug connector having a housing and a mating plug connector that can be plugged together therewith, the main plug connector has a superstructure and the superstructure accommodates a latch element in a prelatching and a final latching position, the main plug connector has first latch formations and the latching element therefore has complementary first latch formations and the mating plug connector has second latch formations and the latching element therefore has complementary second latch formations, the latching element with the first latch formations complementary to one another is initially fixed in the prelatching position on the main plug connector before the mating plug connector is inserted into the main plug connector, inserting the mating plug connector into plug-in connectors actuates the second mutually complementary latch formations, as a result of which the latching element can be moved into its final latching position, the housing and the latching element have third latch formations that correspond to one another and that effect an additional latching of the latching element to the main plug connector when the latter has been moved into its final latching position, the superstructure has a hole and the latch element has a latching lug that can be moved into the cutout, the latching element has an elongate extension arm, on one end of which an actuating part is arranged, the first latch formations are in the front end region of the cantilever that faces away from the actuating part, and the third latch formations of the latching element is in the region of the cantilever that adjoins the actuating part, according to the features of the introductory clauses of patent claim 1.

Plug connection assemblies having a main plug connector and a mating plug connector that can be plugged together therewith, in particular for automotive applications, are known. Because of the rough use conditions of such plug connectors, it is necessary to lock the main plug connector and mating plug connector together. In addition, during assembly, it is necessary for the main plug connector and the mating plug connector to be plugged together, haptic or optical feedback being necessary to determine whether the plug connection assembly has been correctly put together. Latch elements (CPA=Connector Position Assurance) have already become known for this purpose. Known latch elements have first latch formations that interact with complementary latch formations on the main plug connector. As a result of this interacting first latch formations, the latch element can be fixed in a prelatching position on the main plug connector, more precisely on its housing. In this way, it is first ensured that the plug-in connector is connected to the latch element for further assembly, namely the plugging-together operation with the mating plug connector is established without the latch element being able to be lost. From its prelatching position, the latch element can only be moved into its final latching position, but not into another position (such as away from the main plug connector). When the mating plug connector is inserted into the main plug connector, its latch formations cause complementary second latch formations of the latch element to be actuated. These second latch formations serve only to move the latch element can from its prelatching position, which has already been assumed, into its end latching position when the mating plug connector has been inserted in the correct position and completely into the main plug connector. It is only then possible that the second latch formations on the latch element and the mating plug connector make it possible for the latch element to be moved into its final latching position. This is usually a linear sliding movement.

Although this manner of movement of the latch element from its prelatching position into its final latching position has proven itself in principle, disadvantages arise in this case. On the one hand, the latch formations, in particular the second latch formations on the latch element and the mating plug connector, are designed in such a way that regions of the latch element, when the latch formations have assumed the final latching position are in a tensioned state. This means that the latch element is under pressure during the entire service life of the plug connection assembly, so that material fatigue as a result of the rough environmental conditions such as temperature fluctuations, vibrations and the like can result in material fatigue resulting in a break. This, however, disadvantageously causes the mating plug-type connector to move out of the plug-in connector again and thus to open up the plug connection assembly. This can lead to functional failures, but also to safety risks, in particular in vehicles.

Moreover, the disadvantage is that due to the size of the plug connection assembly, the displacement paths from the prelatching position to the final latching position are relatively small (in particular less than 10 mm), so that there is no sufficiently reliable haptic or optical feedback for the assembly person during the assembly of the plug connection assembly (insertion of the mating plug-in connector into the plug-in connector) and subsequent actuation of the latch element.

In order to overcome these disadvantages, in the prior art the housing and the latch element have third latch formations that correspond to one another and that create an additional locking of the latch element to the main plug connector when the latter has been moved into its final latching position. The third latch formations, such as, for example, a latching lug on the latch element that engages in a complementary hole on the housing or the superstructure thereof when the latch element has been moved into its final latching position, can provide either a further optical and/or haptic feedback, indicating that not only the latch element has assumed its final latching position, but that the mating plug connector has also been inserted in the correct position and completely into the main plug connector. In addition, these third latch formations on the latch element and on the main plug connector bring about a further additional locking, so that the plug connection assembly is thereby permanently held together. In this case, the latch element is without tension in its final latching position on the housing. This is achieved by the fact that no more pressures act on the latch element in its final latching position, so that it is mounted without tension in its final latching position. The fixing merely brings about the complementary latch formations on the latch element, which interact with the latch formations on the main plug connector and the mating plug connector. Once all has taken place and the latch element has arrived in its final latching position, the latter is without tension on the plug connection assembly, so that material fatigue as a result of external influences during the service life of the plug connection assembly is effectively avoided.

A plug connection assembly of the generic type described above is known from DE 10 201 5 224 164 [U.S. Pat. No. 10,193,272].

The object of the invention is therefore to improve a plug connection assembly of the known type with a latch element.

This object is achieved by the features of patent claim 1.

According to the invention, the extension arm has two lateral pins in the region between the first front latch formations and the third rear latch formations, the housing has a contact web for an end side of the respective pin at the height of in each case one pin, and the contact crosspiece is at a distance from the housing by a slot. The contact web is thus formed by the housing of the main plug connector. One side of the bearing web projects from the housing itself (thus merges from the latter), while the other sides freely project into the space. As a result, it is possible for one end face of the respective pin to come to rest on one side (side face) of the bearing web. Since the contact web is thus free from the housing and a slot between it and the housing, the contact web can be designed to be flexible if the extension arm with its two flanking pins is introduced into the housing at the level of the contact web. In this case, the spacing between the two bearing surfaces for the respective pins of the two bearing webs is somewhat smaller than the spacing between the two end faces of the two pins, so that, when the latch element is inserted into the housing, the end faces of the two pins come to rest against the side faces of the bearing webs and press them apart slightly, which is thereby possible in such a way that the respective contact web is not only formed by the material of the housing but is spaced apart from the latter by the slot. As a result of this adjustment of the spacings relative to one another, the latch element is clamped and guided in a targeted manner at least during insertion into the housing, but optionally also during further travel so that it cannot be lost and, on further movement, a targeted guidance of the latch element into the housing is achieved. At least in those regions in which, on the path of movement of the latch element into the plug-in connector housing (up to its final latching position), the end faces of the pins come to rest against the contact surfaces of the parallel-running contact webs and the latter are slightly widened, the housing and the latch element are braced against one another such that these two elements do not bear against one another in a stress-free manner. If no contact web is present or is reset in the course of the movement so that the spacing between the contact surfaces of the two parallel contact webs is greater than the spacing between the end faces of the two pins, the contact webs are not pressed apart by the pins such that the two elements (housing and latch element) are tension-free in these regions. The untensioned state of the two elements is preferably to be used when the latch element is in front of or behind the prelatching position and/or in front of or behind the final latching position. Before the prelatching position and between the prelatching position and the final latching position, the latch element is movably clamped between the two bearing webs in order to provide the already mentioned specific guidance of the latch element (in particular when inserting the latch element into the housing before the prelatching position is reached). As a result of the clamping and the release of the latch element during insertion into the housing up to its final latching position, the advantageous effect also has the result that, in the course of insertion, slight force differences occur during displacement of the latch element that are perceptible. As a result, haptic feedback is provided, at which point of the movement sequence the latch element is located just inside the housing

Further embodiments of the invention are described in the subclaims, from which corresponding advantages result. These embodiments and the advantages resulting therefrom are explained in more detail in connection with the following description of the figures with reference to the figures.

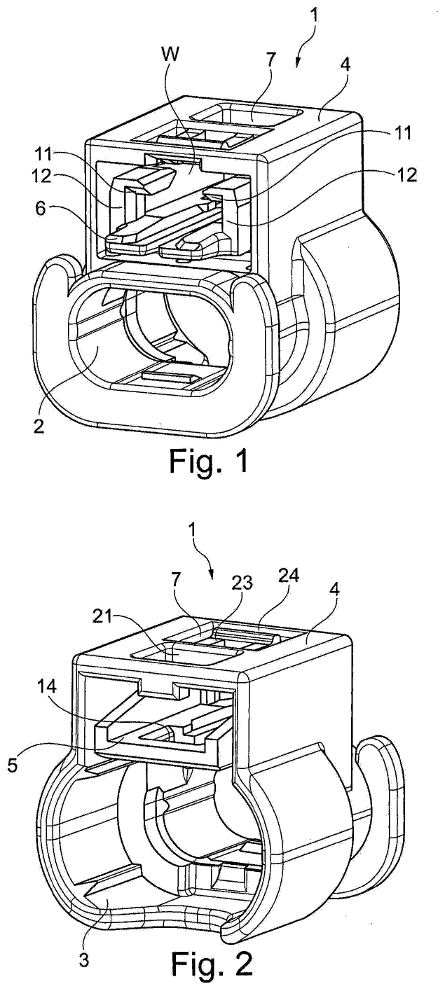

FIGS. 1 to 23 show, to the extent shown in detail, an embodiment of a plug connection assembly having a main plug connector and a mating plug connector that can be plugged together therewith. The configuration of the electrical contacts (for example, the manner in which the contact, single-row, two-row, multi-pole or single-pole and the like) is designed is arbitrary and is not important for an understanding of the invention.

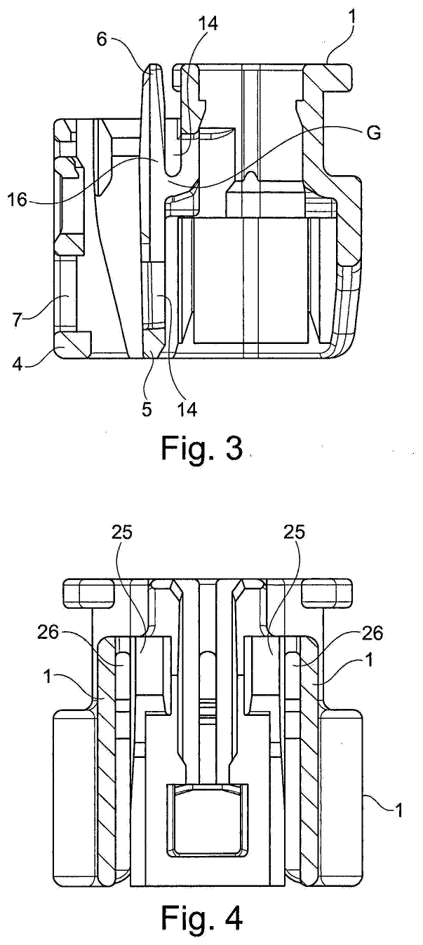

In FIGS. 1 and 2, a housing 1 of a plug connection assembly is shown isometrically in two directions and in section in FIGS. 3 to 5.

The housing 1 has a seat 2 for a contact support (not shown) that can be inserted into this seat 2 and that has contact chambers for a contact partner. A mating plug connector (not shown in detail) can be inserted into a seat 3 formed on the side of the housing 1 facing away from the seat 2.

The housing 1 (also called a protective collar) has a superstructure 4 holding an actuating element to be described below and that interacts with the latch element with its rear part 5 and its front part 6. The superstructure 4 has a cutout 7 on its surface. The cutout 7 is also described in connection with the latch element and its mode of operation.

The same reference numerals used so far are also used in FIGS. 3 to 5 as in FIGS. 1 to 5, which will be discussed in more detail below. Here, attention is directed to the construction of the housing 1. It can be seen that the housing sides 12 have parallel bearing webs 25 that are suitable and designed to accommodate the latch element between them. Each contact web 25 projects from the material of the housing 1, so that the base of each contact web 25 starts at the housing 1 and its remaining portions project freely into the space within the housing 1. The one side face, in particular the side face of the respective bearing web 25, which faces away from the seat for the latch element, is spaced from the wall of the housing 1 by a slot 26. The inwardly mutually confronting side faces of the two bearing webs 25 each extend continuously in one plane or else in at least two mutually deviating planes (as shown in FIG. 4). Due to the configuration of the side faces of the two bearing webs 25 in different planes, it is possible for the latch element to be moved from the start of insertion into the housing 1 up to its final latching position in an alternating manner in a stress-free and non-stress-free manner in the housing 1.

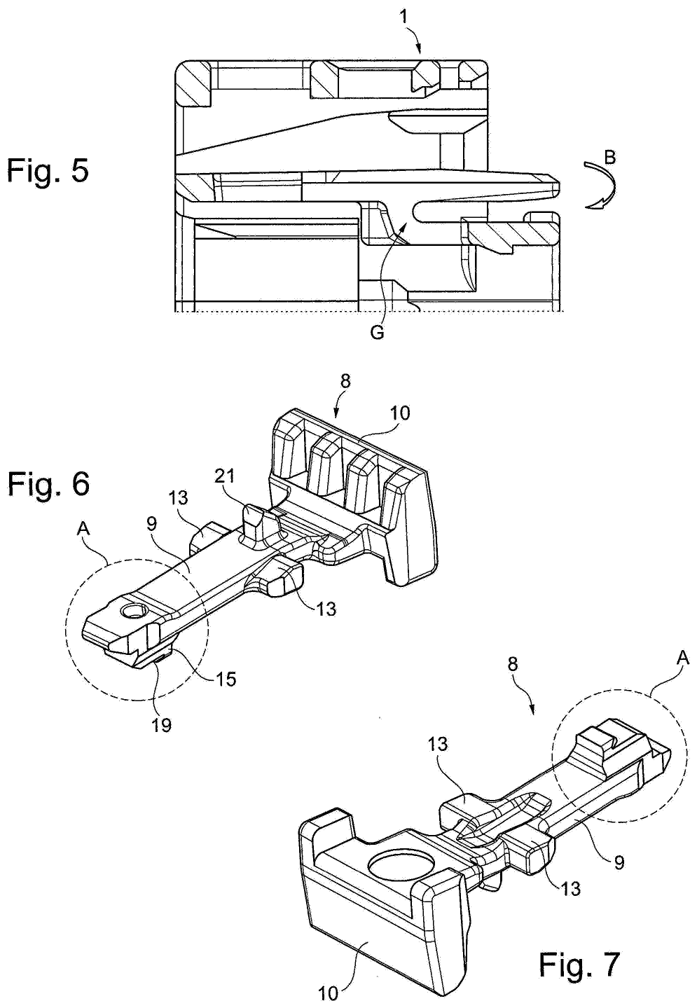

FIG. 5 shows that a connecting part 16 is connected to the housing 1 via a joint web G and can be pressed down because of the joint G in order to receive the latch element (See FIG. 5, by pressing toward movement B onto the front end of the connecting part 16).

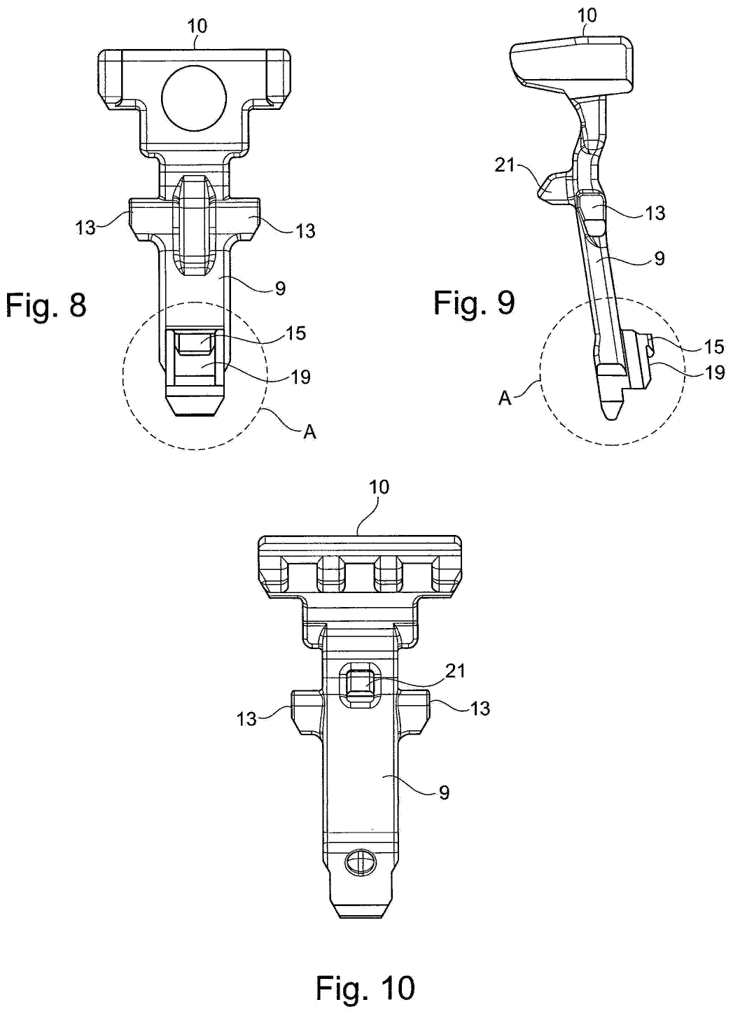

FIGS. 6 to 10 show an embodiment of a latch element 8 (CPA), isometric views being shown in FIGS. 6 and 7 from the front and from the rear and FIGS. 8 to 10 are views of the latch element 8 from above, from the side, and from below.

The latch element 8 essentially has an extension or arm 9, in particular an elongated arm carrying at an outer end an actuating part 10. Latch formations for fixing the latch element 8 to the housing 1 are indicated generally at A.

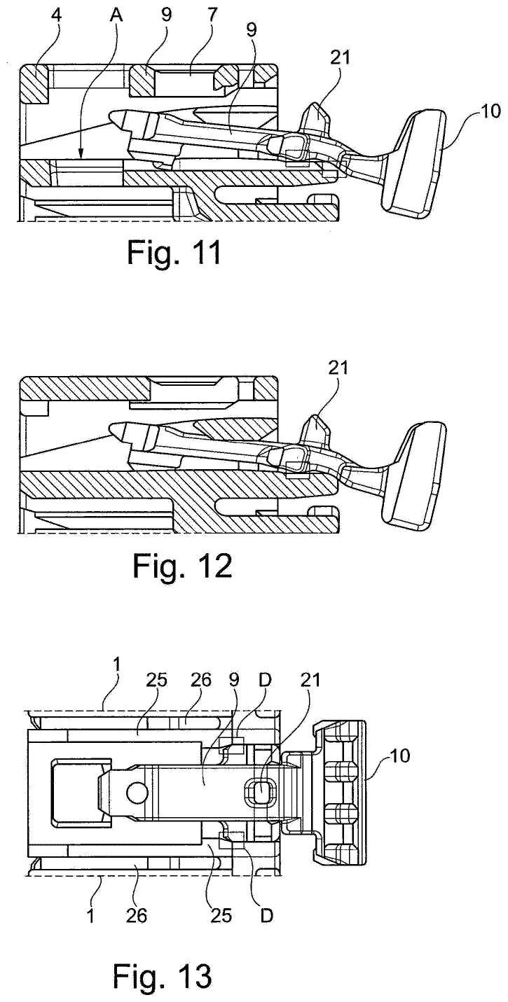

As shown in FIG. 1, the latch element 8 is inserted with the free end of the extension arm 9 where the locking means A are located into a seat W (FIG. 1) and, starting from the front part 6, is pushed in toward the rear part 5. The region between the two parts 5, 6 has, at least on one side, preferably as shown on both sides, a projection 11 that is/are on a side as shown on flanks 12 running parallel to one another. These flanks 12 are located approximately between the flat part 5 and the front part 6 of the actuating element still to be described. In cooperation with the parallel flanks 12, the projections 11 ensure that pins 13, which are preferably carried in the same manner laterally on the extension 9 of the latch element 8, guide the latch element 8 until the latch formations A engage into a hole 14 in the region of the rear part 5 (FIG. 2). This has the effect that, via these complementary latch formations, (hole 14 on the housing 1 and latch formations A on the latch element 8) the latch element 8 is fixed in its prelatching position on the housing 1. In this way, the latch element 8 is captured in the housing 1 and can only be moved linearly into its final latching position when the mating plug connector is inserted into the main plug connector, more precisely the housing 1. The prelatching position of the latch element 8 is first shown in FIG. 11.

It can be seen there that a projection 15 of the latch formations A (see FIG. 6) has come to rest against a side surface of the hole 14 (see FIG. 2). In addition, it can be seen from the two views according to FIGS. 11 and 12 that the pins 13 of the latch element 8 are pressed down by the projections 11 on the housing 1, which prevents the extension arm 9 from moving with its front region where the latch formations A are located, from moving out of the hole 14. If this should be necessary, the front region of the extension arm 9 would have to be moved high under the action of force with a tool, so that the latch formations A can move out of the hole 14 and, as a result, the latch element 8 in its prelatching position can be removed.

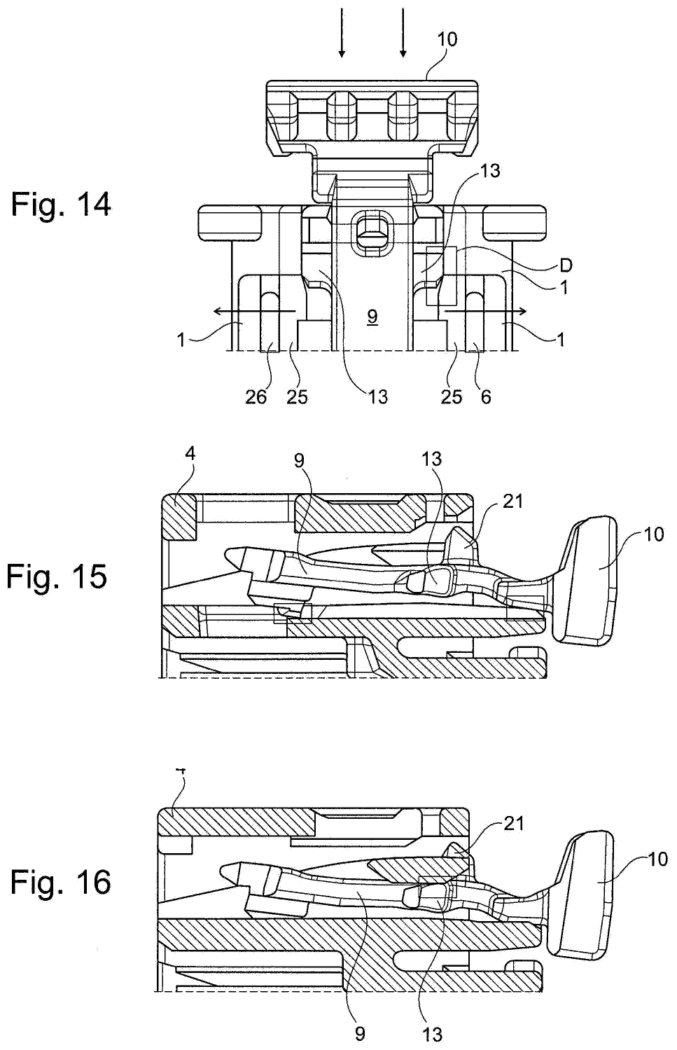

FIGS. 11, 12, 13 and 14 show various sections and views through the housing 1 and complementarily also of the latch element 8. The latch element 8 has already been inserted into the interior of the housing 1 with the front region of the extension arm 9. However, in this state, in FIGS. 11 to 14, the prelatching position is not yet reached, since the latching lug 21 has not yet engaged into the hole in the housing 1. In particular, with reference to FIGS. 13 and 14, it becomes clear that the laterally projecting pins 13 of the extension arm 9 have come to rest in the initial region of the two contact webs 25 running parallel to one another. In order to facilitate further insertion, the pins 13 and/or the initial regions of the two system webs 25 running parallel to one another have insertion bevels. This is shown in FIG. 13 at D, which is shown enlarged in FIG. 14. In this position of the latch element 8 in relation to the housing 1 illustrated in FIGS. 11 to 14, it is not yet clamped between the two bearing webs 25 and is therefore stress-free. Thus, a certain amount of force must be exerted on the actuating part 10, so that the latch element 8 can be moved further into the housing 1. This force is therefore necessary in order to spread the two bearing webs 25 somewhat with the two end faces of the pins 13, since the latter, because of the presence of the two likewise preferably parallel slots 26 is designed to be flexible.

FIGS. 15 and 16 show that by pressing on the actuating part 10, the latch element 8 moves somewhat further along its path of movement into the housing 1. It can be seen here that the end faces of the two pins 13 come to rest against the side faces of the bearing webs 25 and thereby slightly increase the spacing between these two bearing webs 25. As a result, in this region on the path of movement of the latch element 9 into the housing 1, the latch element 9 is somewhat pinched (i.e. is under a prestress) and is guided in a targeted manner and can no longer be lost. However, in the position shown of the latch element 8, the prelatching position is not yet reached.

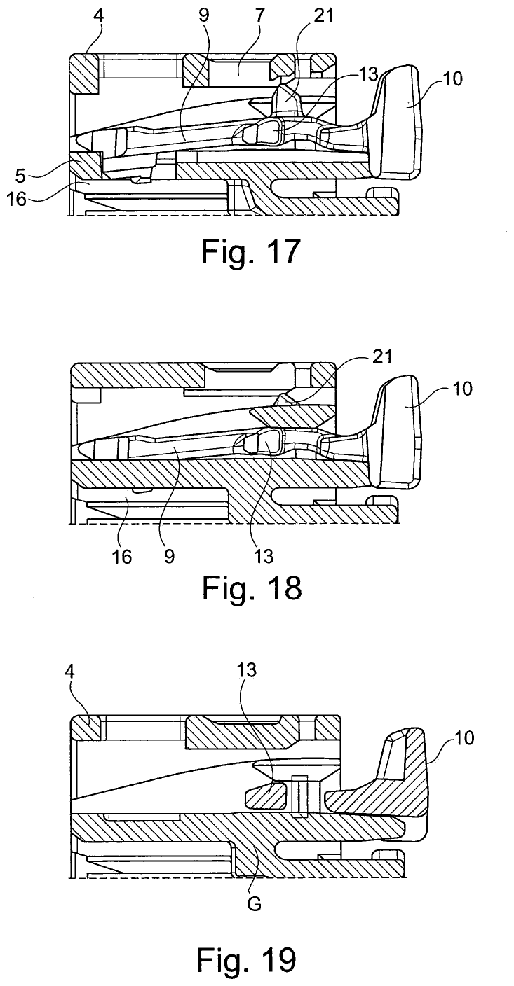

FIGS. 17 to 19 show in various sections that a connecting part 16 extends between the rear part 5 and the front part 6, which connecting part is designed as a type of joint G (or rocker) (see FIG. 5). This is necessary in order that at least the rear part 5 is designed to be movable when the mating plug connector is inserted into the main plug connector. For this purpose, reference is made to FIG. 13. It can be seen here that a mating plug connector 17 with its housing, not designated in detail, on which second latch formations, in particular a latching lug 18, are arranged, is inserted into the seat 3. This latching lug 18, shown here and designed in a beveled version, first of all causes the rear part 5, together with the extension arm 9 and the latch formations A located in the hole 14, to be raised slightly (as viewed in FIG. 3, upward), such that, when a projection 19 of the latch formations A of the extension arm 9 has been raised via the ramp-shaped latch formations of the mating plug connector, in particular the beveled latching lug 18, a further projection 20 of the mating plug connector can dip into the hole 14 between the rear part 5 and the joint G of the connecting part. This projection 20 of the mating plug connector 17, together with the hole 14, forms the second latch formations on the latch element 8 and the mating connectors 17, which fit together. This has the result that, by means of the projection 20 on the mating plug connector 17, the projection 19 on the latch element 9 is raised to such an extent that it is no longer engaged in the hole 14.

Thus FIGS. 17 to 19 show that the latch element 8 has assumed its prelatching position in the housing 1 (in particular in that the latching lug 21 is fixed by complementary mating means formed by the housing 1 in a latching manner but is moved out of this position again and as a result the latch element 8 can be moved further into the housing).

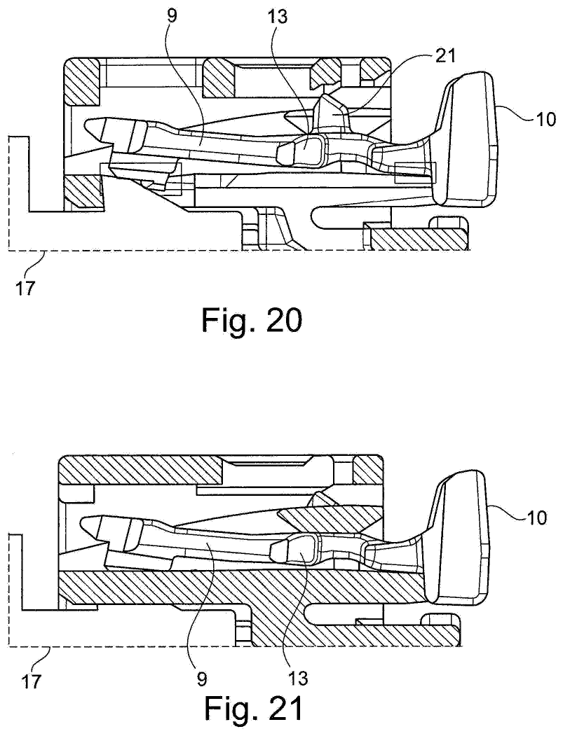

While it has previously been described that a main plug connector 17 can be inserted into the housing 1, it has not yet been shown in FIGS. 1-19. FIGS. 20 to 23 show how the main plug connector 17 is inserted into the housing 1 and, after insertion, the latch element formed by its complementary shape in conjunction with the associated shape of the inner region of the plug-in connector housing 1 can be moved from their previously illustrated latching position into an end latching position.

FIGS. 20 and 21 show in various sections that the latch element 8 is in its tension-free prelatching position and the front end of the extension arm 9 is raised by the insertion of the mating plug connector 17. As shown, the housing of the mating plug connector 17 has, for example, complementary ramp-shaped configurations.

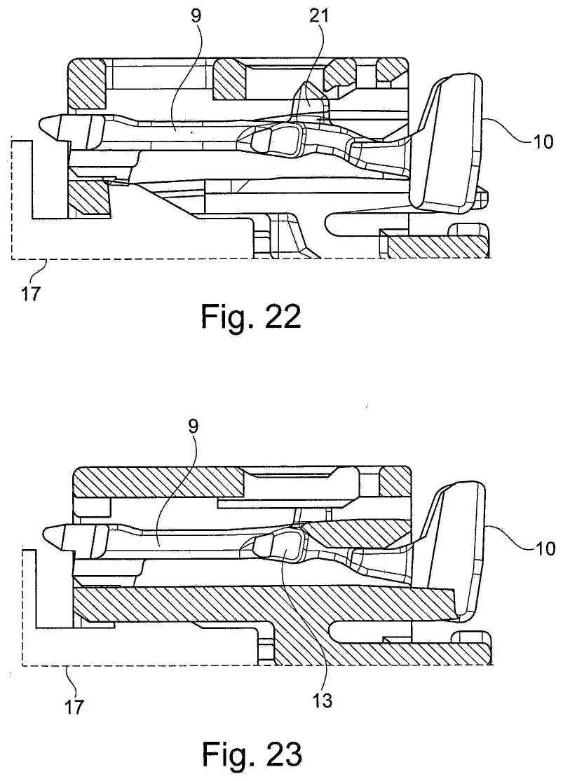

In FIGS. 22 to 23, it is shown in various sections that, by exerting pressure on the actuating part 10, the latch element 8 has been moved further into the housing 1 up to its final latching position. As a result, on the one hand, the complementary shape of the front end region of the extension arm 9 with the ramp-shaped configuration of the mating plug connector 17 is latched to one another. In addition, the latching lug 21 is inserted into its complementary hole in the housing 1 and thus the latch element 8 is fixed in a latching manner to the housing 1. In this final latching position, the latch element 8 is positioned and fixed without tension in the housing 1, since the end faces of the pins 13 of the extension arm 9 of the latch element 8 no longer come into contact with the side surfaces of the contact webs 25.

As already mentioned above, the latch element 9 in its prelatching position is shown in FIGS. 17 to 19. Since in this position the projections 15 come into contact with the projections 11, the front part of the latch element 8 is under prestress that is then cancelled when the latch element 8 has been moved from the prelatching position illustrated in FIGS. 17 to 19 (in various sections) into the final latching position illustrated in FIGS. 22 and 23.

This movement is effected by pressure on the actuating part 10 of the latch element 8, which can now move a certain spacing to the left as shown in the figures. This movement can therefore take place as already described, since the projection 19 of the extension arm 9 of the latch element 8 is no longer engaged in the hole 14. Rather, the underside of this projection can slide on the surface around the hole 14 toward the rear part 5. This causes the latch element 8 to be moved into its final latching position only when the mating connector 17 is properly fitted into the housing 1 according to FIG. 13.

As third interfitting latch formations, the hole 7 on the upper side of the superstructure 4 is provided on the housing 1 and a latching lug 21 that can be moved into the hole 7 is provided on the latch element. The latching lug 21 that is approximately between the pins 13 and the actuating part 10 can be moved by pressure from above onto the actuating part 10 on the underside of the superstructure 4 until it engages into the hole 7. This engagement takes place only when the rest of the latch formations have permitted the mating plug connector 17 to be inserted in the correct position and completely into the housing 1, more precisely its seat 3. Moreover, this also causes the contact partners of the main plug connector and the mating plug connector 17 to have been brought into operative connection with the correct position and completely in order to establish the electrical connection of the main plug connector. Insertion of the latching lug 21 of the latch element 8 into the hole 7 in the superstructure 4 furthermore has the advantage that the latching lug 21 becomes visible, which is a clear indication of a completely assembled plug connection assembly. Depending on the shape of the hole 7 and the detent 21 of the latch element 8, a clearly audible noise (“clicking”) and/or a different expenditure of force (depending on whether the latch element is in the tension-free or non-tension-free state) can also be generated. This is particularly advantageous at the mounting location where the main plug connector and mating plug connector 17 are plugged together and at which a high noise level prevails. It is also important to note that when the latch element 8 has reached its final latching position shown in FIGS. 13 and 14, the pins 13 of the latch element 8 have been guided past the projections 11, and hence the front part of the extension arm 9 is no longer pressed down, but lies freely in its seat. This advantageously ensures that the latch element 7 is engaged without tension in its final latching position on the housing 1.

As seen in FIG. 2, it is pointed out that the hole 7 can not only be designed as a simple hole, but that the hole 7 of the superstructure 4 is formed by approximately U-shaped or rectangular webs whose ends are on the superstructure 4 or a further transverse web 22 in the hole 7. FIG. 2 shows that a web 22 (extending transversely in the plug-in direction) in the middle of the hole 7 (but can also be embodied differently from it). Starting from this web 22 designed as a transverse web, approximately two longitudinal webs 23 running parallel to one another extend at whose other ends a transverse web 24 is arranged. Thus, the hole for the latching lug 21 is approximately rectangular in shape. Instead of this, however, the webs 23, 24 can also be curved, that is to say approximately U-shaped, it also being conceivable for other shapes to be conceivable that permit a hole to be formed by the latter, into which hole the latching lug 21 can dip, and there is an optical or acoustic feedback.

It goes without saying that the housing 1 shown in FIGS. 1 to 5, as well as the latch element 8 and likewise the mating plug connector 17, are designed as one-piece components. These one-piece components consist in a particularly advantageous manner of plastic and are produced in an equally advantageous manner in a plastic injection-molding process.

However, an advantage of the shape of the housing with the latch element inserted there, which both interact with the inserted mating plug connector, is that the latch element in its final latching position not only ensures an effective interlocking of the main plug connector and the mating plug connector, but also that, by means of the third locking means, an optical or acoustic feedback is provided indicating that the plug connection assembly has been correctly plugged together, and in that the latch element rests in the plug-in connector housing in the final latching position without stress without any pressure effect of further elements of the plug-in connector and/or of the mating plug-in connector, in order to avoid material fatigue during the service life of the plug connection assembly, during which the plug connection assembly is no longer separated in the control case.

LIST OF REFERENCE CHARACTERS

| | |
|---|---|
| 1 | Housing |
| 2 | Seat |
| 3 | Seat |
| 4 | Superstructure |
| 5 | Rear part |
| 6 | Front part |
| 7 | Hole |
| 8 | Latch element |
| 9 | Arm |
| 10 | Actuating part |
| 11 | Projection |
| 12 | Flank |
| 13 | Pin |
| 14 | Hole |
| 15 | Projection |
| 16 | Connecting part |
| 17 | Mating connector |
| 18 | Latching lug |
| 19 | Projection |
| 20 | Projection |
| 21 | Latching lug |
| 22 | Web |
| 23 | Longitudinal web |
| 24 | Transverse web |
| 25 | Contact web |
| 26 | Slot |

1. A plug connection assembly comprising a plug-in connector with a housing and a mating plug connector that can be plugged together with the housing, the main plug connector having a superstructure that accommodates a latch element in a preliminary latching position and an end latching position, the main plug connector having first latch formations and the latching element complementary first latch formations, the mating plug connector having second latch formations and the latching element therefore complementary second latch formations, the latch element with the first latch formations complementary to one another being initially fixed in the prelatching position on the main plug connector before the mating plug connector is inserted into the main plug connector, the second latch formations complementary to one another being actuated by inserting the mating plug connector into the main plug connector, as a result of which the latch element is moved into its final latching position, the housing and the latch element having third latch formations that are complementary to one another and that ensure additional locking of the latch element on the main plug connector when the latter has been moved into its final latching position, the superstructure having a latch element and the latch element having a latching lug that can be moved into the latch element, the latching element having an elongate extension arm, at one end of which an actuating part is arranged, the first latch formations being in a front end region of the cantilever that adjoins the actuating part, wherein the extension arm has, in the region between the first front latch formations and the third rear latch formations, two flanking pins, and the housing has a contact web for an end side of the respective pin at the level of in each case one pin, the contact web being spaced from the housing by a slot.

2. The plug connection assembly according to claim 1, wherein the hole of the superstructure is formed by webs that are approximately U-shaped or rectangular and that have ends on the superstructure or a transverse web in the hole.

3. The plug connection assembly according to claim 1, wherein the latch element is without tension in its prelatching position and in its final latching position on the housing.
